(19) United States
(12) Patent Application Publication
(10) Pub. No.: US 2008/0259770 A1
(43) Pub. Date: Oct. 23, 2008

(54) Optical Pick-Up for Use in a Multi-Disc Optical Player and Method for Correcting Optical Aberrations in Such an Optical Pick-Up Unit

(75) Inventors: Petrus Theodorus Jutte, Eindhoven (NL); Joris Jan Vrehen, Eindhoven (NL)

Correspondence Address: BAINWOOD HUANG & ASSOCIATES LLC, 2 CONNECTOR ROAD, WESTBOROUGH, MA, 01581, US

(73) Assignee: Arima Devices Corporation TrustNet Chamers, Road Town (VG)

(21) Appl. No.: 11/792,275

(22) PCT Filed: Dec. 1, 2005
(86) PCT No.: PCT/IB2005/054000

§ 371 Date: Apr. 4, 2008

(30) Foreign Application Priority Data
Dec. 6, 2004 (EP) 04106312.4

(51) Int. Cl. G11B 7/00

(52) U.S. Cl. 369/112.23; 369/100

(57) ABSTRACT

The present invention concerns to an optical pick-up unit for use in a multi-disc system, for scanning a first type of record carriers and at least a second type of record carriers, the second type of record carriers having an information density different from an information density of the first type of record carriers, the optical pick-up unit comprising at least two optical branches (3, 5, 7), a first optical branch (3) having a first radiation source (39) emitting a first radiation beam with a first wavelength, which first radiation beam propagates along a first optical path (4), and a second optical branch (5, 7) having a second radiation source (51, 59) emitting a second radiation beam with a second wavelength, which second radiation beam propagates along a second optical path (6, 8), the first and the second wavelengths and the first and the second optical path (4, 6, 8) being different and the first and the second radiation beam propagating—after having passed the first and the second optical path (4, 6, 8)—along a common optical path (66) comprising an objective lens (73) for focusing the first radiation beam or the second radiation beam at the record carrier (35). The optical pick-up unit is characterized in that at least one of the optical branches (3, 5, 7) comprises an optical component (41, 53, 61) that is movable for correcting an optical aberration in the first or second radiation beam.

The present invention concerns to an optical pick-up unit for use in a multi-disc system according to the preamble of claim 1, an optical player according to the preamble of claim 13 and a method according to the preamble of claim 14.

An optical pick-up unit (OPU) is the key component of an optical storage system called optical player, comprising a drive unit, and an optical pick-up unit for scanning a record carrier. The record carrier can be either an optical disc (CD, DVD, BD) or a magneto-optical disc (MO). CD (compact disc), DVD (digital versatile disc) or BD (blu-ray disc) are optical information storage media, which can be distinguished by their information storage density. CDs are low density information storage media, DVDs are high density information storage media and BD are the latest development of record carriers, allowing an ultra-high density of stored information. Due to the different information storage densities of the CDs, the DVDS and the BDs, the scanning, which means the reading and writing of information on a record carrier by a spot of a radiation beam, requires higher demand on the optical record system, in particular the optical pick-up unit. In general the optical pick-up unit comprises a radiation source, in particular a semiconductor laser, emitting a radiation beam which scans (read and/or write) the information of the record carrier, whereby the wavelength of the radiation source is adapted to the information storage density being required for low density, high density and ultra high density record carriers. In order to increase the read-out and recording capacity the laser wavelength λ is decreased and the numerical aperture of the objective lens is increased. Typically, a laser having a wavelength of λ=780 nm is used for scanning CDs, a red laser with a wavelength of λ=650 nm is used for scanning DVD-s and for BD-s and a blue laser with a wavelength of λ=405 nm is used in the optical pick-up unit. Scanning of CDs, DVDs and BDs, requires radiation sources with different wavelengths. The numerical aperture NA is for CD 0.45, for DVD 0.6 and for BD 0.85. Several companies have developed optical recording systems that are able to scan as well CD-s, DVD-s and BD-s in the optical player. Optical players that can read and write both DVD and BD-s are known as well as optical players that can read and/or write all three types of record carriers (CD, DVD and BD).

For example in the patent application publication US/2004/0114495 A1 an optical pick-up is described, comprising lasers of different wavelengths as well as a plurality of objective lenses, each compatible with the family of optical record carriers.

Optical aberrations in the radiation beam on the record carrier due to a tilt of the objective lens and/or of the record carrier are more severe in an optical information storage system that operates with different record carriers than in an optical player being suitable only for one type of record carriers. This is due to the design of an information recording surface of the record carrier, in particular different spacing of the tracks and the size of the information carrying pits and due to the increased NA (numerical aperture), decreased wavelength in combination with the thickness of the cover layer on the disk.

It is known to correct the optical aberrations by tilting the objective lens that focuses the radiation beam spot onto the record carrier. The tilt of the objective lens, in particular in the radial direction, is now used in most of the optical pick-up units in the optical player for DVDs. The required tilt of the objective lens is a different one for each of the different optical branches comprising the different radiation sources. Therefore it is quite difficult to perform the corrections of the optical aberrations by tilting the objective lens in one direction in a multi disc system that is able to scan different types of record carriers. It is known from prior art, for instance from the US 2004/0114495 A1 to perform the corrections of the optical aberrations by tilting the objective lens in two directions, in particular in the radial direction and the tangential direction.

In particular the whole optical pick-up unit including the objective lens is moved additionally. This results in an active control, but the system comprises many mechanically moved parts. Mechanically moved parts are very expensive, bulky and also susceptible and sensitive for malfunction.

It is an object of the present invention to provide an optical pick-up unit of the type mentioned at the outset, which avoids the above drawbacks. It is a further object to provide a method for a correction of optical aberrations in such an optical pick-up unit. Furthermore the system should be cheap in production and not susceptible for malfunction and easy to handle.

This object is achieved with respect to the optical pick-up unit mentioned at the outset in that at least one of the optical branches comprises an optical component that is movable for correcting an optical aberrations occurring in the radiation beam.

The advantage of this optical pick-up unit according to the present invention is that the correction of the optical aberrations is performed in at least one of the optical branches. Additionally, the correction is performed by moving only one optical component, which is easier to perform. This is preferably an adjustment which is performed only once during the assembly of the scanning device/light path. This method avoids mechanically movable elements that are complicated and expensive.

A further advantage of the optical pick-up unit according to the present invention is that the correction of the optical aberrations can be arranged separately in every of the optical branches and adapted to the different types of record carriers of the optical pick-up unit. This leads to a further possibility of optimization of the scanning quality of the recorded information. It is further advantageous that due to the arrangement of the correction of optical aberration in at least one of the optical branches, the light can propagate along a common optical path that can comprise other optical components, for instance, a detection element which is part of the optical pick-up unit.

The working principal of the optical pick-up unit is described shortly in the following. The radiation beam emitted from a first radiation source propagates along a first optical branch in which the optical component for correction is arranged. After having passed a first optical path the radiation beam is directed into a common optical path of the optical pick-up unit, the radiation beam is then directed onto an reflecting element which directs the radiation beam onto an objective lens which focus the radiation beam onto a information recording surface of the record carrier. The radiation beam is then reflected from the information recording surface of the record carrier and propagates along the common optical path of the optical pick-up unit onto a detection unit, which detects the radiation beam. The detection element detects also the deviation from an ideal position of the radiation beam. It is clear from this description of the working principal that most of the optical elements, such as, the detection element, the objective lens and the reflecting element are disposed only one time in the optical pick-up unit, because they are part of the common optical path. This allows a cheap optical pick-up unit.

In a preferred embodiment of the present invention, the optical component comprises a precollimating component, having a central lens axis.

Advantageously the collimating component for correcting an optical aberration has collimating functions as well as the task to transform a radiation beam from radiation source, preferably a semi-conductor laser into a parallel radiation beam, which can then pass other optical elements and be directed and converged by the objective lens towards the record carrier to form a light spot onto a pit train on a track of the information recording surface of the record carrier. Light reflected from the record carrier is converged by the objective lens and directed by an optical element to a detector. The detector contains several segments in order to generate for instance a focus error signal and radial tracking signals. The actuator moves the objective lens along the optical axis on response of the focus error signal in order to keep the spot on disk in focus. The tracks on disk are followed by means of the radial movement on the actuator (fine tracking) and the radial movement of the whole housing of the light path (long range tracking).

In particular, in this embodiment the optical component is a collimating or pre-collimating component with a central lens axis. The central lens axis is displaced with respect to the optical axis of the common optical path. Therefore, advantageously, both the objective lens and the collimating component can be moved according to the focus error signal and according to the quality of the focused radiation beam on the record carrier.

According to another preferred embodiment of the present invention, the optical component is arranged between the radiation source in the at least one optical branch and an optical element directing the radiation beam on the common optical path.

This allows directly to perform the correction of optical aberrations caused by a tilt of the objective lens and/or a tilt of the record carrier in the at least one optical branch where the optical component is arranged. Further it allows the adjustment of the optical performance of the optical component to the properties of the radiation beam emitted from the radiation source.

According to another preferred embodiment of the present invention the central lens axis of the optical component is displaced against the optical axis of the common optical path.

The displacement of the central lens axis of the optical component causes, intentionally additional to the aberrations caused by the tilt of the objective lens or the record carrier, optical aberrations in at least one branch of the optical pick-up unit. This intentionally caused optical aberration is intended to compensate the optical aberration caused by the tilt in the objective lens or are tilt of the record carrier. This results in a correction of the radiation beam on the information recording surface of the record carrier and therefore a better scanning quality of the record carrier is obtained.

According to a further embodiment of the present invention, the optical component is displaced by a tangential shift Δ, resulting in a shift of Δ in the central lens axis with respect to the optical axis of the common optical path.

This shift is preferably an adjustment which is performed only once during the assembly of the scanning device.

According to a further embodiment of the present invention the optical component is displaced by rotation of the central length axis around one of the nodal points of the optical component.

The rotation around one of the nodal points of the optical component has the advantage that the image of the radiation source will not be shifted with respect to the optical axis of the common optical path.

In a further embodiment of the present invention, the radiation source is additionally displaced by an amount that is related to the shift Δ of the central lens axis of the collimating optical component.

When the central lens axis is shifted with respect to the optical axis of the common optical path by a certain distance, the image of the radiation beam will remain in the same place when the radiation source is shifted also.

In a further embodiment of the present invention, the shift of the laser has a fixed amount of (m−1)·Δ.

When the shift of the radiation beam is (m−1)·Δ, the image of the laser will remain in the same place when the lens is shifted with a distance Δ with respect to the optical axis of the common optical path. The quantity m is a magnification of the optical component. If this condition is fulfilled the spot of the radiation beam is kept centered on the detector, even if the central lens axis of the optical component is shifted, during the adjustment procedure when assembling the scanning device/light path.

In a further preferred embodiment of the present invention, one of the at least two optical branches comprises a radiation source for scanning an ultra-high density optical record carrier.

The optical pick-up unit for scanning an ultra-high density optical record carrier (BD) is extremely sensitive for optical aberrations, because of the very narrow tolerances caused by a very small distance of the pits and a shorter length of the pits due to the ultra-high density of the stored information. Therefore the correction of optical aberrations is extremely important in an optical pick-up unit that is suitable for scanning ultra-high density record carriers and low-density record carriers.

In a further preferred embodiment of the present invention the optical pick-up unit comprises these at least three optical branches. Three optical branches allow the scanning of three different types of record carriers, for instance the scanning of low density record carriers (CDs), high density record carriers (DVDs) or/and ultra high density record carriers (BDs) or also the scanning of magneto-optical record carriers (MO) with the same optical player.

The object is also achieved by an optical player with a drive unit and an optical pick-up unit according to the invention.

The correction of optical aberration in the optical pick-up unit used in an optical player allows that the optical player is able to scan different types of record carriers with a good scanning quality. This is because the optical aberration caused by a tilt of the record carrier or an unintentionally tilt of the objective lens or unwanted coma generated in the light path can be corrected in at least one of the optical branches by moving the optical component in this optical branch. Therefore the correction can be adapted to the requirements of the optical branch specifically and the tolerances that are used/required in this optical branch can be considered.

The object is also achieved by a method for correction of optical aberrations in an optical pick-up unit used in a multi-disc system, wherein a first type of record carriers and at least a second type of record carriers are used, the second type of record carriers having an information density different from an information density of the first type of record carriers, comprising at least two optical branches, a first optical branch having a first radiation source emitting a first radiation beam with the first wavelength, which first radiation beam propagates along a first optical path, and a second optical branch having a second radiation source emitting a second radiation beam with a second wavelength, which second radiation beam propagates along a second optical path, the first and the second radiation beam having different wavelengths and the first and the second optical paths being different and the first and the second radiation beam propagating—after having passed the first and the second optical paths—along a common optical path with an objective lens for focusing the first radiation beam or the second radiation beam at the record carrier by generating an optical aberration by moving an optical component in at least one of the optical branches.

According to the invention the generated optical aberration is a coma.

Generally the tilt of an objective lens or the tilt of the record carrier causes a coma as optical aberration. Therefore the intentionally caused coma in at least one of the optical branches advantageously corrects the coma caused by the tilt of the objective lens or the tilt of the record carrier.

According to the invention the optical aberration is generated by displacing a optical component having a central lens axis by a tangential shift Δ.

This shift Δ is preferably an adjustment which is performed only once during the assembly of the scanning device.

According to the present invention, the radiation source of the optical pick-up unit is additionally displaced by an amount of (m−1)·Δ wherein m is a magnification of the optical component.

To displace additionally the radiation source is important to keep the spot of the radiation beam centered on a detector being arranged in the common optical path of the optical pick-up unit.

According to the present invention, the central lens axis of the optical component is displaced against the optical axis of the common optical path by rotation of the optical component around one of the nodal points of the optical component. When the rotation is around one of the nodal points of the optical component, the image of the radiation source will not shifted with respect to the optical axis of the common optical path.

These and other objects and advantages of the present invention will become more apparent from the following description with reference to the accompanying drawings, wherein:

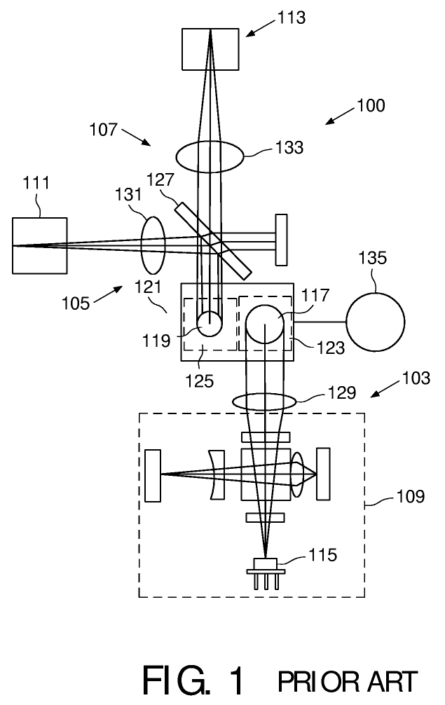

FIG. 1 is a schematic view of the optical structure of an optical pick-up unit with three scanning branches for different optical record carriers;

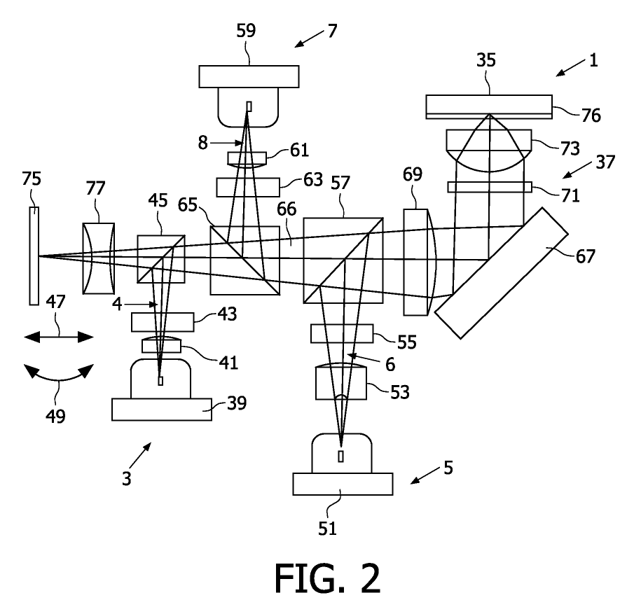

FIG. 2 is a schematic view of a light pass configuration for CD, DVD and BD optical record carriers according to the present invention;

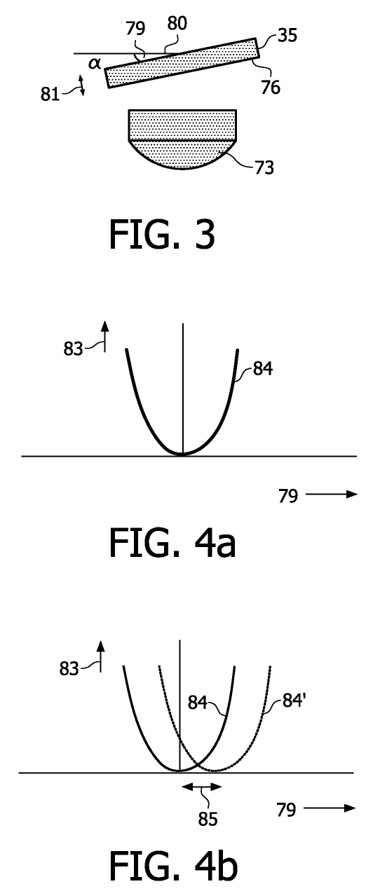

FIG. 3 is a schematic view of a record carrier tilted with respect to an exit surface of an objective lens;

FIG. 4 is an illustration of a jitter caused by optical aberrations due to a disc tilt;

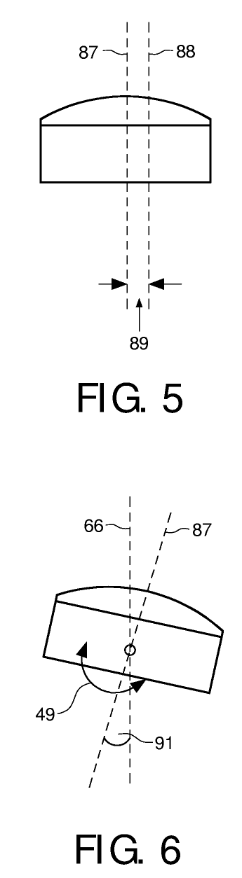

FIG. 5 is a schematic view of a pre-collimating component with a shifted central lens axis with respect to a common optical axis of the OPU;

FIG. 6 is a schematic view of a pre-collimating component, showing a rotation of the central lens axis.

Now, the present invention will be described below with reference to the accompanying figures of the drawing in accordance with the embodiments. For convenience in the description, information storage media are called record carriers. For a low density record carrier such as a compact disc the abbreviation CD is used, for a high density record carrier the abbreviation DVD is used and for ultra high density record carrier the abbreviation BD is used. This includes both only read and/or read and write record carriers.

FIG. 1 shows a schematic view of an optical pick-up unit (OPU) 101, of the prior art, taken from US 2004/0114491 A1 which is designed such as to be comfortable with various types of record carriers with different recording density, like CD, DVDs and BDs. The OPU 101 comprises three branches 103, 105 and 107, each of the branches 103, 105, 107 is being suitable for another optical storage media. Please note that in the figure the record carrier is not depicted. Each of the branches 103, 105 and 107 comprises an optical unit 109, 111 and 113, respectively. The key parts of the optical units 109, 111 and 113 are radiation sources emitting laser light (in the following called radiation beams) with different wavelengths. Radiation source 115 in the optical unit 109 is shown in place of the other radiation light sources. The radiation beams of optical branches 105, 107 and of optical branch 103 are focused individually by a first objective lens 117 and a second objective lens 119 and are focused incident upon the record carrier (not shown). Objective lens 117 and objective lens 119 are mounted on an actuator 121 of the optical units 109, 111 and 113. The first and second objective lens 117 and 119 focus incident radiation beams so that the incident light beams are focused as optical spots on a recording surface of the record carrier (not shown). The actuator 121 drives the first and the second objective lens 117 and 119 in a focusing and/or tracking direction. The path of radiation beams emitted from the optical units are changed by reflection mirrors 123 and 125 so that the emitted beams are incident upon the first and second objective lenses 117 and 119. However, the radiation beams emitted from the optical units 109, 111 and 113 may be directed incident upon the first and second objective lens 117 and 119 without the inclusion of the reflection mirrors 123 and 125. The optical unit 111 comprises a light path changer 127. There can be a beam splitter with a color sensitive coating, which transmits for instance the CD and reflect the DVD beam or the other way round. In the optical light path of all three branches 103, 105, 107 there are also collimators 129, 131 and 133 arranged. The light path changer 127 is disposed between the second optical unit 111 and the second optical lens 119. The first collimating lens 129 is disposed between the first optical unit 109 and the reflection mirror 123. The second collimating lens 133 is disposed between the second optical unit 111 and the first light path changer 127. The third collimating lens 131 is disposed between the third optical unit 113 and the first light path changer 127. In the document of the prior art, taken from the patent application publication US 2004/0114491 A1 the optical unit 109 is described as having the radiation source, which is a laser with a short wavelength like a blue violet laser with a wavelength of 405 nm, the second optical unit 111 is described having a red laser with a wavelength of 650 nm and a third optical unit 113 is described comprising a near infrared laser suitable for CDs with a wavelength of 780 nm. Further details can be taken from this patent application publication and will not described here, because it does not belong to the present invention.

To summarize the set up of the optical pick-up unit according to the prior art, this optical pick-up unit is designed for use in the multi disc system being able to scan three type of record carriers, wherein the information density of the three type of record carriers are different from each other. The optical pick-up unit comprises two optical branches, a first optical branch having a first radiation source emitting a first radiation beam with a first wavelength, which first radiation beam propagates along a first optical path, and a second optical branch having a second radiation source emitting a second radiation beam with a second wavelength, which second radiation beam propagates along a second optical path. The wavelengths of the two radiation beams emitted by the two radiation sources are different from each other as well as the two optical paths. The two radiation beams are directed to a common optical path including the objective lens 119. The third optical branch comprises a third radiation source emitting a third radiation beam having a third wavelength. The third wavelength of the third radiation beam is different from the wavelength of the first and the second radiation beam. The third radiation beam does not use the common path of first and second radiation beams and also comprises an additional objective lens 117 to focus the radiation beam onto the record carrier. Nevertheless, both objective lenses 117 and 119 are mounted on a common actuator 121 and can be moved. Additionally it is described to move the whole optical pick-up unit to perform corrections of the optical aberrations caused by a tilt of one of the objective lenses 117 and/or 119 and/or the tilt of the record layer. The actuator moves the objective lens along the optical axis on response of the focus error signal in order to keep the spot on disk in focus. The tracks on disk are followed by means of the radial movement on the actuator (fine tracking) and the radial movement of the whole housing of the light path (long range tracking). The tilt between lens and disk can be corrected dynamically in one direction, by means of a tilt generated by the actuator.

Because of the use of two lenses and two detectors the tilt of the BD lens and the CD/DVD lens can be adjusted independently during assembly of the light path. This is not the case when a single lens and a single detector are applied.

FIG. 2 shows an schematic view of an optical pick-up unit 1 (OPU) of the present invention.

The optical pick-up unit shown in FIG. 2 is an example for an embodiment of an optical pick-up unit 1 to be used in an optical player (not shown) suitable for scanning record carriers with different information density. The shown optical pick-up unit is designed to scan three different types of record carriers, in particular a record carrier with low information density, a record carrier with high information density and a record carrier with ultra-high information density. It is understood that this embodiment is only an example of multi disc system of an optical player and does not limit the present invention. In this embodiment of an OPU 1 a light path configuration with three optical branches 3, 5 and 7 is shown, whereby branch 3 show the DVD branch, branch 5 the BD branch and branch 7 the CD branch. The figure is an “Egyptian view” and has to be interpreted as follows: recording branch 37, including a set folding mirror-λ/4plate-disc and the objective lens 73 as well as the record carrier 35 should be rotated by 90° into a plane perpendicular to the surface of the paper. That is why in the optical pick-up unit 1 of FIG. 2 the optical record carrier 35 can be seen, even if the record carrier 35 is not arranged in plane with the optical branches 3, 5, 7. This branch is assigned as a disc-writing branch 37 in the following. The branches 3, 5, 7 are assembled in principle in the same way, comprising a radiation source, a pre-collimator lens and a grating as well as a beam splitter for directing the radiation beam into a different optical path. Branch 3 includes a radiation source 39 (e.g. being suitable for writing and reading DVD's with high information density), a pre-collimator lens 41, a grating 43 as well as a beam splitter 45. A pre-collimator lens is a lens that changes the vergence of the radiation beam in order to increase the coupling efficiency of the laser. The radiation beam after a pre-collimator is divergent and not parallel as holds for a collimator. In this example the pre-collimator 41 in branch 3 can be shifted either tangential or rotational as shown with arrows 47 and 49 respectively. Branch 5 comprises a radiation source 51 e.g. suitable for scanning (writing/reading) record carrier with ultrahigh information density, for example, a semiconductor laser emitting a radiation beam with a wavelength of about 405 nm. Branch 5 further includes a lens 53 that has the function of a beam shaper, a grating 55 as well as the beam splitter 57. The branch 5 is suitable for scanning an optical record carrier 35 with ultrahigh information density. Branch 7 comprises a radiation source 59, a pre-collimator 61, a grating 63 as well as a beam splitter 65 and is designed as to scan CDs with low information density. The radiation source 59 is preferably a laser with a wavelength of about 780 nm.

In the following the function of the three branches 3, 5, 7 are described. The radiation beams emitted by the radiation sources 39, 51 and 59 are transmitted by the components 41, 53 and 61 as well as the gratings 43, 55 and 63. In the optical components 45, 47, 65 each laser beam is directed onto a common optical path 66. After each of the optical components 45, 57 or 65 the radiation beam, independently from the radiation source that produces the radiation beam, prolongate along this common optical path towards the objective lens 73 and consequently be directed to and focused on the record carrier 35 (which can respectively be a DVD, BD or CD).

Further in the common optical path 66 a mirror 67 is included as well as in front of the mirror 67 a collimator 69. In the recording branch 37 a quarter wave plate 71 and an objective lens 73 are arranged. A detector 75 detects the radiation beam that is reflected from the information recording surface 76 of the record carrier 35. In front of this detector 75 a lens 77 is arranged to adapt the optical quality of the radiation beam, for example by introducing astigmatism. The way of functioning of the branches 3, 5, 7 can be described as follows.

A radiation beam from one of the radiation sources 39, 51 or 59, which are preferably semiconductor lasers, is formed into a pre-collimated radiation beam by the collimators 41 or 53 or 61 respectively. The radiation beam is traveling along an optical path 4, 6 or 8 respectively and passes through a polarizing beam splitter 45, 57 or 65, and is converged by an objective lens 73 towards an optical disc 35 to form a light spot (scanning spot) onto the information recording surface 76 of the record carrier 35. Light reflected from the information recording surface 76 of the record carrier 35 is converged by the objective lens 73 and directed by the mirror 67 to the detecting lens 77 and is finally incidenting on the detector 75. It should be mentioned at this point, that the invention is not limited to the use of the specific components such as, for example, beam splitters and mirrors. The invention may also include other optical components being able to change the direction of the radiation beam.

The detector 75 may contain several segments in order to generate, for instance, a focus error signal and radial tracking signal. An actuator (not shown) moves the objective lens along the optical axis in response to the focus error signal in order to keep the scanning spot on disk in focus. The tracks on disk are followed by means of the radial movement of the actuator (fine tracking) and/or the radial movement of the whole housing of the light path (long range tracking).

The function of the optical pick-up unit 1 is described for one of the branches 3, 5 and 7 respectively as following in relation to FIG. 2. A radiation beam emitted from one of the radiation sources 39, 51 or 59, which are preferably semiconductor lasers, is transformed into a pre-collimated radiation beam by a pre-collimator lens 41, 53 or 61, the radiation beam then passes through a polarizing beam splitter 45, 57 or 65, reflected by mirror 67 to a quarter wave plate 71 and converged by an objective lens 73 towards a record carrier 35 to form a scanning spot on an information recording surface 76 of record carrier 35. Light reflected from the record carrier 35 is converged by the objective lens 73 and directed by the mirror 67 to a detecting lens 77. The converged radiation beam transmitted by collimator lens 69 forms a spot image near the center of the light-receiving surface of photo detector 75.

The photo detector 75 serves as detection element for all three branches 3, 5 and 7. The detection error signal can therefore detect an optical aberration like a coma. Coma may be produced by tilted optical elements in the common optical path 66. The objective lens 73 can cause coma as well as a record carrier 35. The amount of coma (W₃₁RMS) of a tilted record carrier being tilted by an angle of α can be given by the following formula:

$${W}_{31} R MS = \frac{- {n}^{2} ( {n}^{2} - 1 ) \cdot sin α \cdot cos α}{2 \sqrt{72} {( {n}^{2} - {sin}^{2} α )}^{\frac{5}{2}}} \cdot d \cdot {NA}^{3} ,$$

wherein d the thickness of the disc, n is the refracting index of the record carrier, α is the angle disc tilt and NA is the numerical aperture of the objective lens 73. The relation between the coma and the angle α is depicted in FIG. 3 showing the record carrier 35 and the objective lens 73 as well as the angle 79 indicated between a straight line 80 expressing an angle of 0° and being identical with the surface of a non-tilted record carrier 35. The thickness 81 of the record carrier 35 can also be seen in FIG. 3. By the coma, being an optical aberration, the accuracy of the light spot on the information recording surface 76 of the record carrier 35 is influenced and with that the scanning quality of the high frequency signal. The quality of the high frequency signal can be expressed in terms of jitter. Jitter may be understood as a timing error of the zero crossing of the high frequency signal. The relation between the angle 79, record carrier and the jitter 83 is shown in FIG. 4. It can be seen that the jitter is 0 if the angle 79 is α=0°, that means the record carrier is not tilted expressed in FIGS. 4a and 4b curve. The curve has at α=0°, —no disc tilt—a minimum of the jitter 83. In other words the optical pick-up unit 1 is properly aligned in radial as well as tangential direction. This curve expressing the dependency of the jitter 83 from the tilt angle 79 of the record carrier is called a bathtub curve 84. For the different optical branches 3, 5, 7 the position of the bathtub curves may be depicted as function of the angle α. As can be seen in FIG. 4b the bathtub curves 84 and 84′ (dotted line) show an offset 85 as indicated. That means that bathtub curves 84 and 84′ have an offset 85 of the point of jitter 83 being zero. The offset 85 of the jitter curve can corrected, as shown in prior art optical pick-up units, by tilting the objective lens in the optical pick-up unit. If the coma occurs only in one of the branches 3, 5, 7 the jitter correction (by tilting the objective lens 73) is always a compromise and a point of minimum jitter will not be reached for all the branches of the optical pick-up unit 1.

In particular, due to tolerances and differences in the optical paths of the DVD and BD the point of minimum jitter 83 for BD and DVD will usually not coincident as can be seen in FIG. 4b. Consequently the tilting of the objective lens cannot be done for both of the branches 3 and 5 being designed to scan the record carriers 35 (e.g. a BD or a DVD). This is why a bathtub correction of the prior art could result in a bad scanning performance for one of both record carriers, BD or DVD. Therefore, as shown in FIG. 2, the bathtub correction is performed in at least one of the optical branches 3, 5 or 7. As an example it is shown in FIG. 2 a bathtub correction in branch 3, 5 or 7 wherein the optical pick-up unit 1 comprises an optical component 41, 53 or 61 suitable for bathtub correction. In particular the optical component 41, 53 and 61 is a pre-collimating component arranged between the radiation source and the grating. This pre-collimating component may be movable or shiftable in a tangential direction (as indicated with arrow 47 for branch 3) or in a radial direction (as indicated with arrow 49 for branch 3). As indicated with arrow 47 the shift of the pre-collimating component 41 is performed by shifting the central optical axis 87 of the collimating component 41 with respect to the optical axis of the common optical path 66 of the optical pick-up unit 1. In particular if the shift is of the amount Δ and the radiation source 39 is shifted by an amount (m−1)·Δ the imaged spot of the radiation source 39 is kept centered on the detector 75. The shift of the central lens axis 87 of the pre-collimating component 41 is shown in FIG. 5, wherein the central lens axis 87 is marked with the reference sign 87 and the optical axis of the pick-up is reference sign 88. The shift is indicated with a reference sign 89. In the formula m is the magnification of the pre-collimating component 41. That means that the shift of the radiation source with respect to the optical axis is depending on the magnification m of the pre-collimating component 41. It is also possible to rotate the pre-collimating component 41 over an angle 91 as seen in FIG. 6. The optical axis of the common optical path 66 of the optical pick-up unit 1 and the central lens axis of the pre-collimating component 41 are shown.

If the rotation angle 91 is in or around one of the nodal points of the lens, the image of the radiation source 39 will not be shifted with respect to the optical axis of the common optical path 66. A nodal point is a point on the optical axis and is constructed like the following: When both the incoming and the outcoming rays of the radiation beam are extended until they meet the optical axis, they meet in the nodal points. It should be emphasized that the bathtub correction can be arranged in all of the three branches 3, 5 and 7 and that the bathtub correction is performed by a pre-collimating component in each of the branches 3, 5 and 7. The pre-collimating component is then displaced either tangentially or radial or rotated in, preferably, one of the nodal points of the pre-collimating component. It is important for a correct bathtub correction that the spot of the radiation beam is not displaced on the detector 75 after a displacement or rotation of the pre-collimating component 41.

The embodiment shown in FIG. 2 is an example of an optical pick-up unit 1 including a bathtub correction and should be seen as an example that does not limit the invention. The basic idea of the invention is that bathtub correction is arranged in at least one of the optical branches 3, 5 or 7 and can perform the bathtub correction individually for each branch when necessary. With this embodiment the optical pick-up unit 1 comprises only one objective lens 73 that is common for all three optical branches 3, 5 and 7 and is arranged in front of the information recording surface 76 of the record carrier 35. The system also comprises a single detector 75 in common that detects the radiation beam reflected from the information recording surface 76 of the record carrier 35 and is used for creating an error signal for the bathtub correction. With the error signal the shift, displacement or tilt of, for example, the pre-collimating component 41 in branch 3 may be adjusted during assembly in order to minimize the jitter when scanning a record carrier. The means for displacing or tilting such a pre-collimating component are not discussed here in details. It can, for example, be done mechanically or electromechanically. It may also be possible to apply a device, such a micro mechanical device (for example using MEMS technology), that allow for a small shift or tilt of the component.

1. An optical pick-up unit for use in a multi-disc system and for scanning a first type of record carriers and at least a second type of record carriers, the second type of record carriers having an information density different from an information density of the first type of record carriers, the optical pick-up unit comprising at least two optical branches, a first optical branch having a first radiation source for emitting a first radiation beam with a first wavelength, which first radiation beam propagates along a first optical path, and a second optical branch having a second radiation source for emitting a second radiation beam with a second wavelength, which second radiation beam propagates along a second optical path, part of the optical path of each of the optical branches being a common optical path, wherein at least one of the optical branches comprises an optical component in a part of the optical path different from the common optical path and which is adjustable in order to correct optical aberration in a scanning spot for one of the record carriers.

2. An optical pick-up unit according to claim 1, wherein the optical component is adjustable for correcting coma in the scanning spot.

3. An optical pick-up unit according to claim 1 wherein the optical component comprises a pre-collimating optical component having a central lens axis.

4. An optical pick-up unit according to claim 1 wherein the optical component is arranged between the radiation source of the at least one of the optical branches and an optical element which directs the first and/or second radiation beam onto the common optical path.

5. An optical pick-up unit according to claim 1 wherein a central lens axis of the optical component is displaceable with respect to the optical axis of the common optical path.

6. An optical pick-up unit according to claim 5 wherein the optical component is displaceable by a tangential shift Δ, resulting in a shift of Δ of the central lens axis with respect to the optical axis of the common optical path.

7. An optical pick-up unit according to claim 5 wherein the optical component has a nodal point and is displaceable by a rotation of the central lens axis around the nodal point.

8. An optical pick-up unit according to claim 6 wherein the radiation source of the at least one of the optical branches is additionally displaceable by an amount which is related to the shift Δ of the central lens axis of the optical component.

9. An optical pick-up unit according to claim 8 wherein the radiation source is additionally displaceable by a fixed amount of (m−l)−Δ, wherein m is a magnification of the optical component.

10. An optical pick-up unit according to claim 1 wherein the radiation source of one of the at least two optical branches is arranged to emits a radiation beam for scanning a record carrier with an ultrahigh information density.

11. An optical pick-up unit according to claim 1 wherein the optical pick-up unit comprises at least three optical branches.

12. An optical pick-up unit according to claim 11, wherein each of the at least three optical branches is designed for scanning a CD, a DVD, a BD and/or a MO.

13. An optical player for scanning a first type of record carriers and at least a second type of record carriers, the second type of record carriers having an information density different from an information density of the first type of record carriers, wherein the optical player comprises a drive unit and at least one optical pick-up unit according to claim 1.

14. A method for correction of an optical aberration in an optical pick-up unit used in a multi-disc system, wherein a first type of record carriers and at least a second type of record carriers can be scanned, the second type of record carriers having an information density different from an information density of the first type of record carriers, the optical pick-up unit comprising at least two optical branches, a first optical branch having a first radiation source for emitting a first radiation beam with a first wavelength, which first radiation beam propagates along a first optical path, and a second optical branch having a second radiation source for emitting a second radiation beam with a second wavelength, which second radiation beam propagates along a second optical path, the first and the second radiation beam each having a different wavelengths and the first and the second optical path being different from each other and the first and the second radiation beams being arranged to propagated at least in part along a common optical path comprising an objective lens for focusing the first radiation beam and the second radiation beam on the record carrier wherein the method includes generating an optical aberration in a part of the optical path of the at least one of the optical branches different from the common optical path.

15. A method according to claim 14, wherein the generated optical aberration is a coma.

16. A method according to claim 14 wherein the optical aberration is generated by displacing an optical component, having a central lens axis, by a tangential shift Δ.

17. A method according to claim 16, wherein the optical component is a pre-collimating element.

18. A method according to claim 16 wherein the radiation source is additionally displaced by an amount of (m−l)−Δ, wherein m is a magnification of the optical component.

19. A method according to claim 16 wherein the central lens axis of the optical component is displaced with respect to the optical axis of the common optical path by a rotation of the optical component around a nodal point of the optical component.

20. An optical pick-up unit for use in a multi-disc system and for scanning a first type of record carrier and at least a second type of record carrier, the second type of record carrier having an information density different from an information density of the first type of record carrier, the optical pick-up unit comprising at least two optical branches, a first optical branch having a first radiation source for emitting a first radiation beam with a first wavelength, which first radiation beam propagates along a first optical path, and a second optical branch having a second radiation source for emitting a second radiation beam with a second wavelength, which second radiation beam propagates along a second optical path, part of the optical path of each of the optical branches being a common optical path, wherein at least one of the optical branches comprises a pre-collimating optical component in a part of the optical path different from the common optical path and which is adjustable in order to correct coma in a scanning spot for one of the record carriers, the pre-collimating optical component being arranged between the radiation source of the at least one of the optical branches and an optical element which directs the first and/or second radiation beam onto the common optical path.
